(19) United States
(12) Patent Application Publication
(10) Pub. No.: US 2015/0239016 A1
(43) Pub. Date: Aug. 27, 2015

(54) Parts Washer

(71) Applicants: Steve Spencer, Provo, UT (US); Stephan Westcott, College Place, WA (US)

(72) Inventors: Steve Spencer, Provo, UT (US); Stephan Westcott, College Place, WA (US)

(21) Appl. No.: 13/757,095

(22) PCT Filed: Jul. 28, 2011
(86) PCT No.: PCT/EP2011/063042

§ 371 Date: May 7, 2015

(30) Foreign Application Priority Data
Aug. 2, 2010 (EP) 10008044.9

(51) Int. Cl. B08B 3/00; B08B 3/14; B08B 3/02; B08B 3/10

(52) U.S. Cl. CPC B08B 3/006; B08B 3/106; B08B 3/14; B08B 3/026

(57) ABSTRACT

A parts washer comprising an upper portion and a lower portion, in which the part may be washed in the upper portion and the lower portion includes a drum for containing the aqueous cleaning solution. A method of washing an article in a parts washer and a method of regenerating the cleaning solution within the parts washer are also disclosed.

### FIELD OF THE INVENTION

This disclosure relates to a heated high pressure water based parts washer which may be used to wash dirt, oil and grease and other materials from mechanical parts which have been removed from larger devices, such as vehicles, for cleaning. More particularly, the parts washer incorporates a comprehensive onboard water treatment function to regenerate the washing liquid in-situ.

### BACKGROUND

Cleaning and de-greasing operations in the industrial and automotive sector require a balance between chemistry, heat, mechanical action, and time. Organic based solvents generally maintain a high Kb (Kari-Butanol) value and require less heat and mechanical energy or time when removing fats, greases and oils. The lack of heat and kinetic energy required makes these organic solvents a very simple solution for most applications. The cleaning ability or cleaning horsepower in aqueous solvents alone cannot match the cleaning performance of organic solvents on greases and oils and therefore they require the balance to shift from chemistry to heat, kinetic energy and time, with time being the most relevant drawback.

Aqueous cleaning machines today can be broken down into two categories, manual and automatic. The manual machines generally use a brush to provide the kinetic energy, while the automatic washers use flow or pressure and time to provide the mechanical cleaning action. Both of these operations require that the lack of solvency from the detergent be made up by time as both operations require long cleaning cycles as neither provide the real time cleaning solutions offered by the organic solvents.

An object of the present invention is to focus the kinetic energy, heat and the solvency of the detergent in such a way as to provide real time cleaning while using an aqueous solvent. The design of the parts washer of the present invention enables all of these components to come together in a focused event that provides fast and efficient cleaning.

Oil and contaminants that are introduced into the cleaning solution will continually degrade the performance of the chemistry as well as create an environment that is damaging to the pump and pressure system. The design of the equipment provides a chemical and mechanical process to clean and extend the life of the cleaning solution.

Parts Washers using organic solvents rely on the cleaning effectiveness of the solvents themselves to perform most of the de-greasing tasks. Because of the effectiveness of these solvents a simple submergible pump is all that is required to provide a low pressure liquid flow. These pumps can be submerged into a drum of solvent from the top and as no outlets are needed below the solvent level the integrity of the drum is never compromised. The drum is an integral part of the equipment as it provides the vessel for the solvent storage as well as the shipping container when the cleaning solvent reaches the end of its useful life. During a drum exchange, the pump is removed out of the top of the drum; the drum is then fitted with a closure and is then used as the shipping container for delivery to an offsite disposal or recycling center.

In order to match the effectiveness of organic solvents, water based solvents must be enhanced through the use of heat and pressure. The present invention addresses and overcomes the difficulties traditionally associated with a water based system within the confines of a 110 liter drum, while maintaining the integrity of a UN/DOT shipping container. The controls and design criteria within this design include, but are not limited to the following: liquid level alarm; heating element; flooded suction for the pressure pump; providing particulate free fluid for a positive displacement high pressure pump; and a reaction vessel to provide separation of contaminants, oil, and water. Further details about these will be set out in the description of the present invention below.

Parts washer rental route service operators require that their inventory of rented parts washers be drum mounted to allow for the quick exchange of drums in the field while providing a shipping container for the new and waste product. It is the object of this invention to provide a water based parts washer that will meet or exceed the cleaning performance of organic based solvents, while preserving the preferred form of drum mounted equipment for rental route operators.

The present invention outlines a parts washer where an onboard water reclamation system will extend the life of the cleaning solution beyond that of any static detergent bath system, and the drum based storage vessel is fully portable by use of a specific decoupling system. This decoupling system allows flooded suction to the pressure pump while eliminating any fittings extending from the drum. The equipment is also designed around a specific combination of detergents and clarifying agents that allow for chemical clarification of the cleaning solution within the drum.

According to the present invention there is provided a parts washer comprising: an upper portion including a sink basin, a lid through which two integrated heavy duty gloves are passed and fixed, a viewing panel, a high pressure nozzle, and a drain from the sink basin; and a lower portion including a drum for containing the aqueous cleaning solution, a high pressure pump for pumping solution from the drum to the high pressure nozzle, a down tube passing from the drain from the sink basin in the upper portion into the drum for passing excess liquid from the upper portion back to the lower portion for regeneration and re-use, heating means within the drum for heating the cleaning solution, and safety and control means for operating the parts washer.

Optional and preferred features will be described below in the accompanying claims and in the description of an embodiment of the present invention. For example, the upper section may further include a frame for supporting the part to be washed and/or an air knife for cleaning the viewing panel. The upper section may also further include an air spray to dry a washed part.

The nozzle may be a manual nozzle to be picked up and moved during use by the operator. Alternatively the nozzle may have a fixed location in the sink basin and the part is moved around to expose all surfaces to the water jet, The fixed location could be varied to accommodate different shapes or sizes of parts. There may also be two or more nozzles present, either fixed or manual.

In one preferred embodiment, the lid may comprise a four bar lid mechanism to assist in the opening of the lid to allow access to the parts to be washed, and also to improve the positioning of the lid with respect to the user. The lid is lockable in to operation, and in a preferred embodiment may be locked by means of a reed switch, which may be located between two layers of the lid. This provides an effective and secure mechanism for locking the lid before operation, which does not rely on the operator physically moving a locking switch.

The drum may have a specially adapted bung to enable liquid to pass from the drum to the pump without extending past the outside of the drum. This enables the drum to still be used as a shipping container to transport the solution to the site and to ultimately remove the waste material once the solution has been regenerated sufficient times that the solution is no longer efficient for cleaning.

The invention also extends to a method of washing an article, in which an article is placed inside the upper portion of a parts washer according to the present invention, the lid of the washer is closed and locked, a user places their hands inside the integrated heavy duty gloves which pass through the lid of the washer, the system is switched on, the pump draws cleaning liquid from a drum contained within the washer and passes it to a nozzle in the sink basin of the upper portion, the user uses the jet of cleaning liquid from the nozzle to clean the dirt off the article, excess cleaning solution passes through a drain to a down tube and into the bottom portion of the drum.

The invention further extends to a method of regenerating a cleaning solution in a parts washer, in which dirty solution from a sink basin passes through a down pipe into a drum containing cleaning solution at a level some way below the top surface to maintain a quiet zone at the top of the drum, a clarifier is added to the aqueous based mixture to separate the aqueous solution from the oil based waste, a quiet zone at the top of the drum allows the different parts to separate, after separation the oil based layer is drawn off from the drum, the aqueous solution is topped up to the appropriate level with fresh water, the solution is chemically tested and additional cleaning solution is added as appropriate. In a preferred embodiment, this method of regenerating is applied to the parts washer of the present invention.

Preferred and optional features described with reference to the apparatus apply equally to the method of operation and to the method of regeneration.

The present invention may be put into effect in a number of ways and one, non limiting example, is described in further detail here with reference to the accompanying figures, in which:

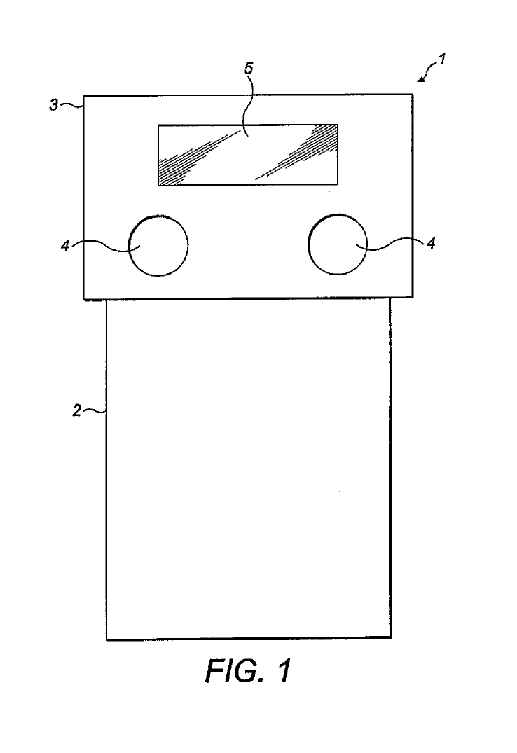

FIG. 1 shows schematically a parts washer according to the present invention;

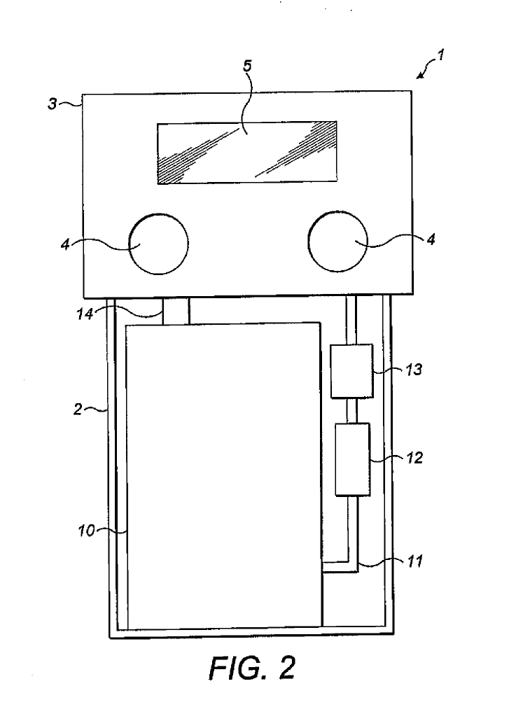

FIG. 2 shows the parts washer of FIG. 1 wherein the internals of the base portion are exposed;

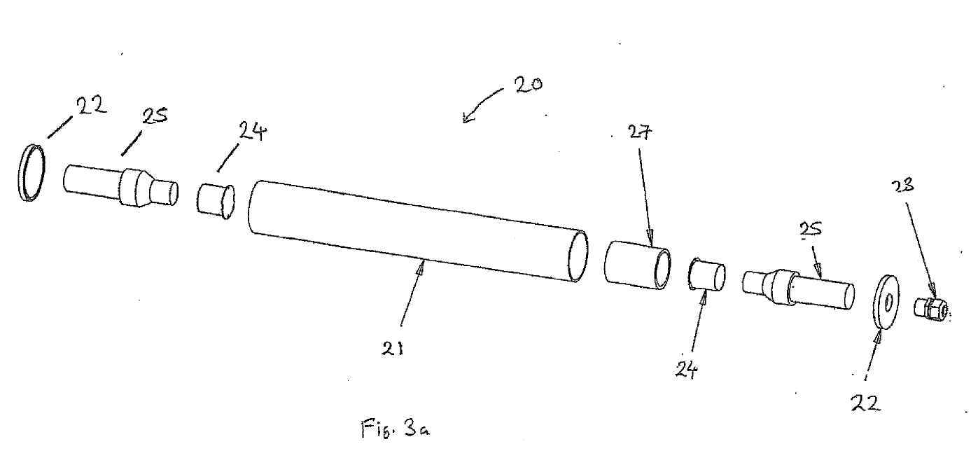

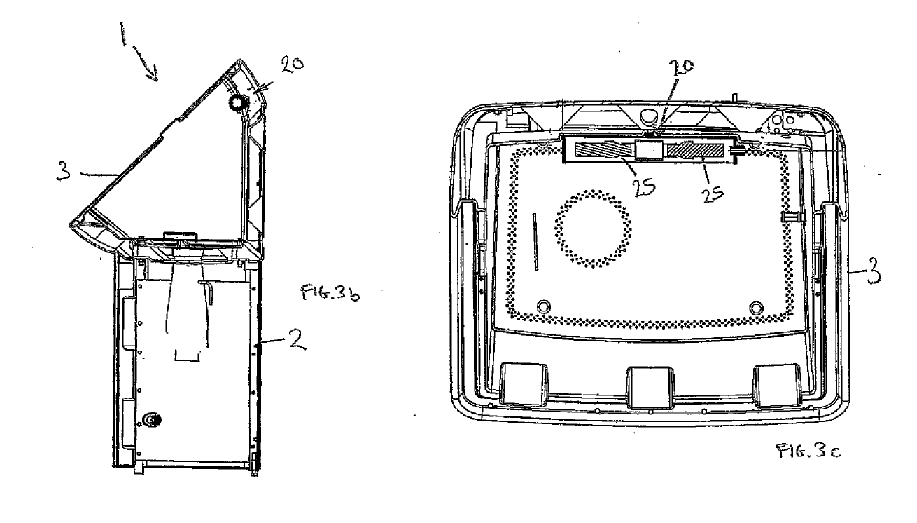

FIG. 3a shows an exploded view of the light in the upper portion and FIGS. 3b and 3c shows the location of the light in an embodiment of the present invention;

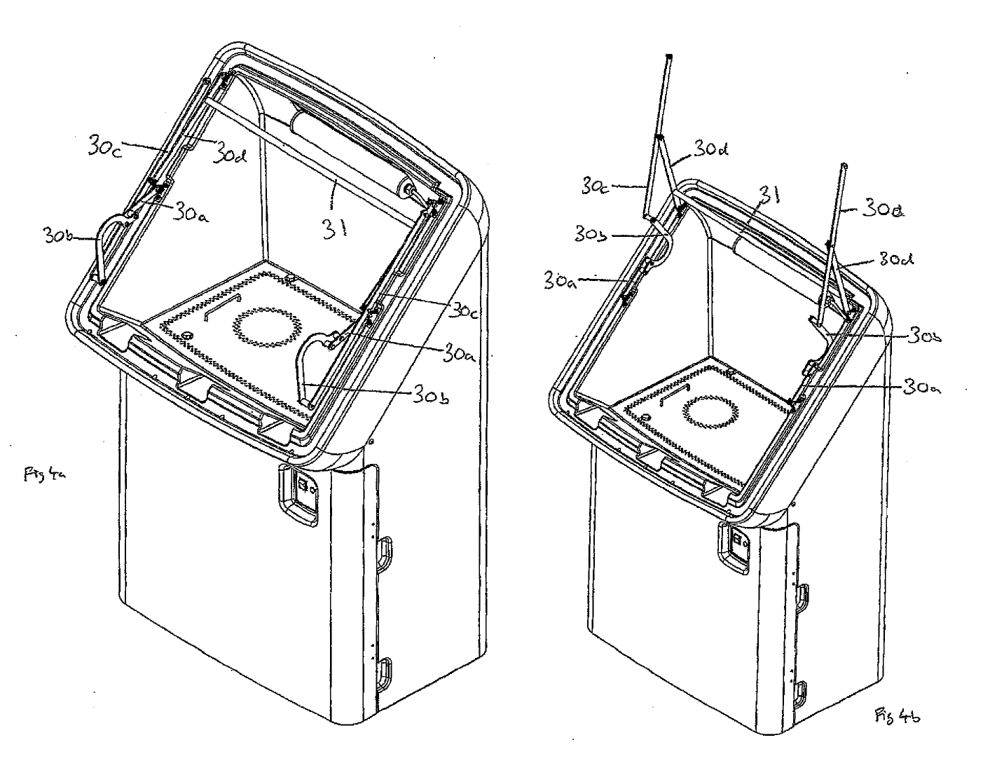

FIGS. 4a and 4b show the four bar mechanism of the lid of the present invention;

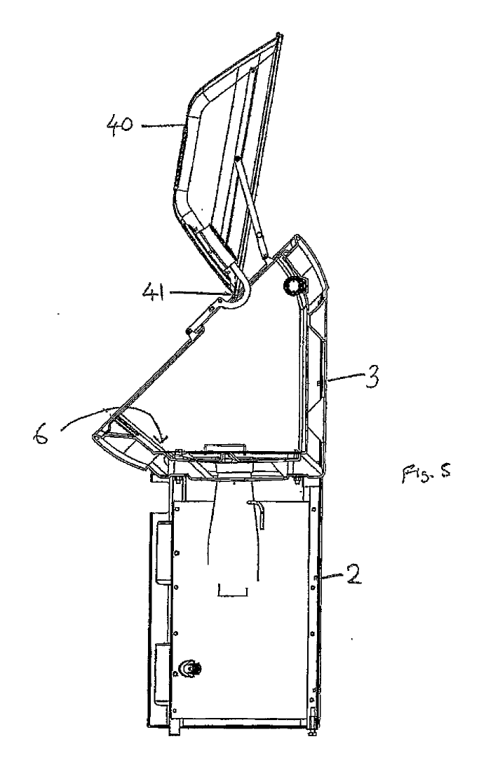

FIG. 5 shows the parts washer with the lid in the open position;

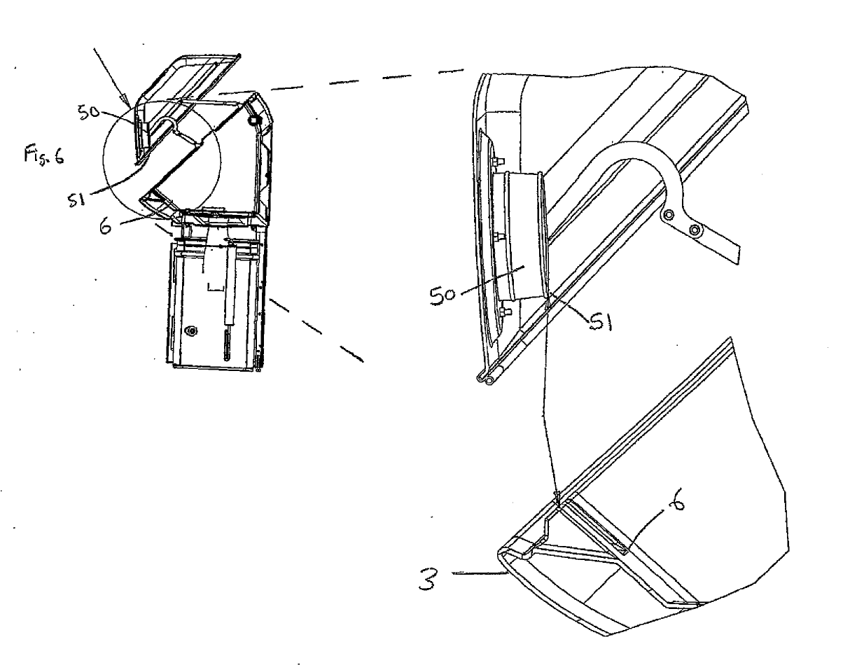

FIG. 6 shows the lid partially open;

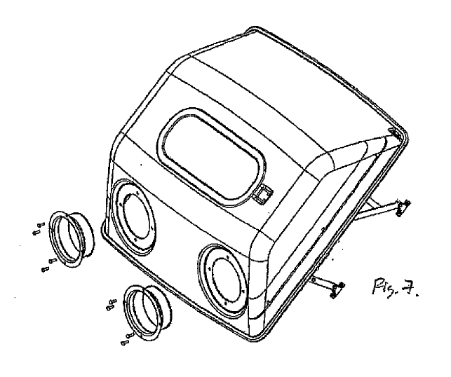

FIG. 7 shows the relative positions of the glove ports in the lid;

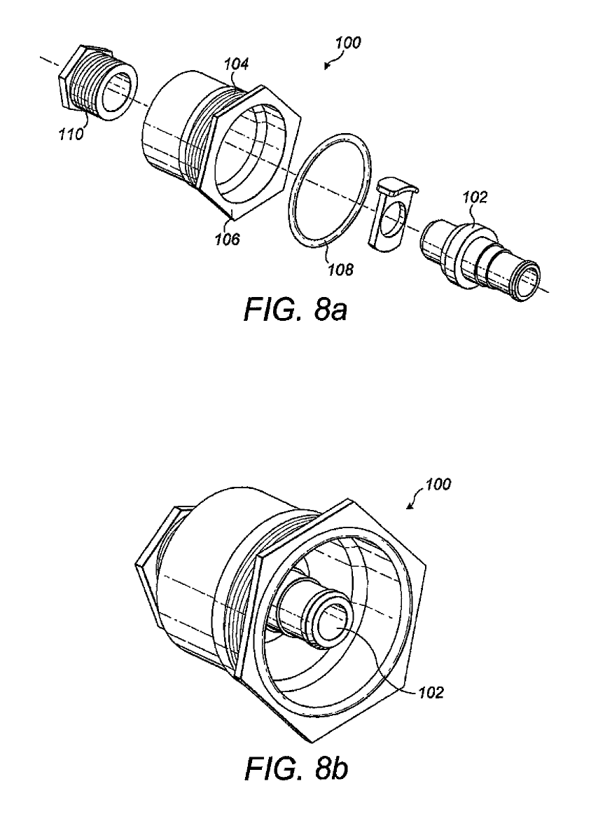

FIGS. 8a and 8b show a specially adapted bung for use in the drum in the washer of the present invention;

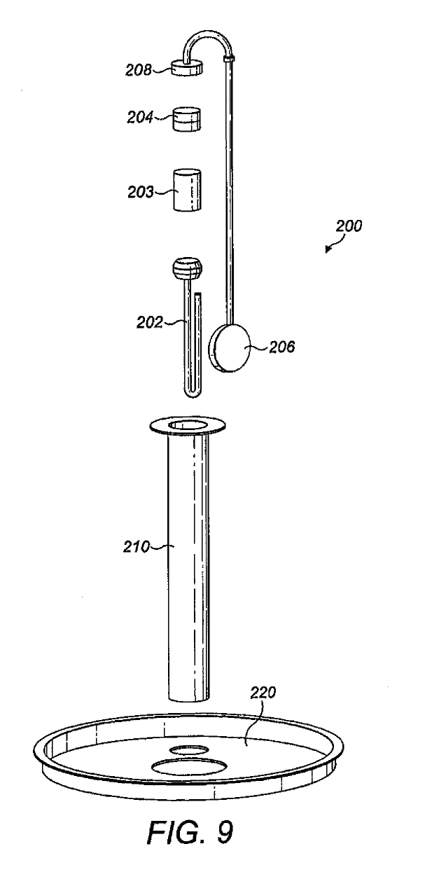

FIG. 9 shows a “heater assembly” for use in the present invention; and

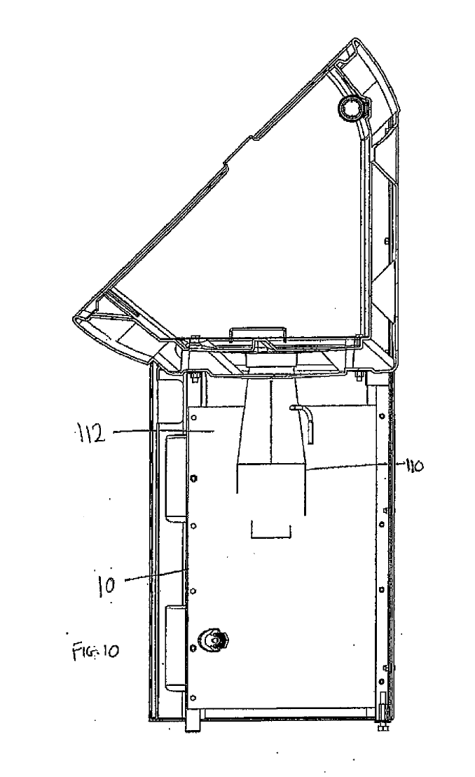

FIG. 10 shows an embodiment of the down tube passing from the upper portion down into the drum.

Referring to FIG. 1, the present invention comprises a water-based parts washer 1 which may be used to clean dirty parts which have been removed, for example, from a motor vehicle. The parts washer 1 comprises a base portion 2 and an upper portion 3. The base portion 2 houses the cleaning solution, the operational controls and the high pressure pump and this is shown in more detail in FIG. 2. The upper portion comprises a sink basin which may or may not include an internal frame or basket for holding the part to be washed, and a lid. The lid includes two integrated heavy duty gloves which are secured to the lid at inlet holes 4. The lid also includes a viewing window 5 through which the user can see the item to be washed and so can direct the nozzle to clean the part thoroughly. Within the parts washer 1 there is one or more one flow-through nozzle (not shown) which is fed by the high pressure pump from the base portion of the washer unit.

FIG. 2 shows the parts washer 1 with the base part 2 exposed to show the internals schematically. The base part includes a washer drum 10 which contains the washing solution. The drum 10 passes washing liquid via pipe 11 to pump 12 which in turn feeds the nozzle assembly which is housed in the upper portion. The operation of the pump 12 drawing washing liquid from drum 10 is controlled by control means 13 which may be situated at any convenient position in the device. Excess fluid from the wash in the sink basin in the upper portion returns to the drum 10 by means of a down tube 14 which extends down into the drum.

In order to optimise the operation of the parts washer, the upper portion in the present embodiment has the following features. The upper portion is fitted with a specific lighting system. Since the cleaning environment in the washer is inside an enclosure, good internal lighting is necessary for the user to be able to effectively clean parts. This is however a very harsh environment and the light must be adequately protected from high-pressure, temperature, and chemicals. According to one preferred embodiment and referring to FIG. 3a the light 20 is housed in a tempered glass sleeve 21, capped on either end by a flexible PVC pipe cap 22, each of which is securely fastened and sealed into place with a hose clamp 23. Chemical and water-resistant power cable is fed into the light through a water-tight cable gland placed in one of the end caps. Inside the light are standard bayonet-cap style lamp holders 24 mounted in a socket separator 27, which take a standard consumer-style CFL (compact fluorescent light) bulb 25.

FIGS. 3b and 3c show the relative location of the light in the upper portion of the parts washer. The light 20 is housed at the top and rear of the upper portion 3 of the part washer 1. It is located away from where the part to be washed is located and provides good light for the whole of the sink basin.

The use of a consumer bulb overcomes shortcomings with lighting in other washers in the market. Firstly, they typically use a non-integrated ballast, separate from the fluorescent bulb and secondly they use a single, non-standard fluorescent bulb. This means that if either the light or ballast fail (which all do at some point), the machine will be unusable until new parts have arrived, which will have to be specially ordered. The use of standard CFL bulbs which are readily available at just about any store that sells household items overcomes this problem. These bulbs also integrate the ballast and bulb into one unit, so there is not guesswork about whether it's the ballast or bulb that has failed—you simply replace the complete bulb unit. Finally, and most importantly, there are two bulbs in the light. The chances of both bulbs failing simultaneously are extremely slim. When one fails, you can still use the machine with half the light while a spare bulb is procured.

The lid of the upper unit is locked closed in operation so that the washing of the dirty part takes place in a restricted environment thereby avoiding the dangers of hot, high pressure liquid coming into contact with the operators. The lid may be locked by means of a reed switch. There are a number of different mechanical interlock switches available on the market, but many have operational problems. Some of them have to be aligned just right, and when misaligned, they tend to break. Most require the user to physically latch the lid in order to keep the mechanical interlock engaged. To make the washer of the present invention as easy to use as possible, it was important to make the interlock system both reliable and seamless to the user. A reed switch accomplishes both. It is so seamless that most users believe that there is in fact no interlock system in place at all.

A reed switch is an electrical switch operated by an applied magnetic field. A magnetic field (from an electromagnet or a permanent magnet) will cause the reeds to bend, and the contacts to pull together, thus completing an electrical circuit. The stiffness of the reeds causes them to separate, and open the circuit, when the magnetic field ceases. The primary advantage of a reed switch is that no physical contact is needed to activate the switch—only the presence of a magnetic field.

In the washer of a preferred embodiment there is a magnet mounted on the lid, and a reed switch mounted inside of the sink basin at the top right hand corner of the upper portion as you face the parts washer. The magnet must be within about 5 cm (2 inches) of the reed switch to activate it, and this can only occur when the lid is closed. In one preferred arrangement, a magnet is mounted on the upper right corner of the lid, out of view from the user. The reed switch is mounted on a specifically designed bracket inside of the sink basin (not shown). Since the sink basin is double walled (due to its' rotationally-molded design), the reed switch can be mounted in between the two walls, completely protecting it from the environment. The increased distance between the magnet and the reed switch, is overcome by choosing a reed switch that is extremely small in size, yet has a wide operating gap of up to 5 cm (2 inches), permitting it to work reliably even though there are two plastic walls between the magnet and the switch (the lid and one wall of the sink.)

The window 5 in the lid of the washer 1 will inevitably become dirty in operation. Much like a car must have windshield wipers, the window on a manually-operated high pressure parts washer must be kept clear of water and soap suds so that the user can see what he or she is doing. Given the harsh operating environment of the washer, however, anything with moving parts inside of the cabinet, such as a windshield wiper, will quickly become contaminated and fail. One alternative without any moving parts is to blow air over the screen to keep it relatively clean.

Unfortunately, this is typically an inferior method of cleaning and the results are poor. Some systems have tried using a channeled air from a fan, while others have tried compressed air through crimped pipes, but the results have been poor. In a preferred embodiment of the present invention an air knife is used, which manages to bring together the best of both worlds: effective cleaning without any moving parts. An air knife is also self-cleaning—any contamination that builds up near the outlet of the air knife will be blown off by the compressed air, which results in an extremely reliable design. The air knife is preferably located at the front bottom edge of the lid, near to the glove portions. This enables a user to quickly get the knife (even when he or she can't see it) and use it to clear the window.

Most air knives on the market suffer from at least one of three problems: they are not very effective, they consume too much air, or they are too noisy. In a preferred embodiment of the present invention, an air knife with 16 tiny outlet orifices is used, oriented next to each other in a straight line. Each orifice creates a tiny vortex stream of air, which more effectively cleans a surface. These 16 vortices together provide a very effective clean of the window, while consuming less air and operating quietly.

A further major problem consistently found in high-pressure washing systems is that it is difficult and awkward to get parts in and out of the sink. Most designs have access from one of the sides, which cannot be accessed from the same position as the operating position. This type of design also requires that a large amount of space be left beside the machine, simply to be able to load and unload parts. Other designs put the access in the front, but the opening and closing of the lid always interferes with the fixed access gloves attached to the front. All of these designs have the disadvantage of dripping water onto the user as a part is unloaded, just after spray washing.

In a preferred embodiment of the present invention, there is a standard four-bar mechanism on the lid, with a couple of modifications, which overcomes these problems. A four bar mechanism allows a lid to be opened by pulling back and up on it. The four bars guide the lid through an upward curve. When the lid is all the way up, it holds itself in position. To move the lid back down, it must be lifted up and back again. The primary advantage of the four-bar design of the present invention is that it is extremely easy to use, and does not require the user to move from the operating position to open or close the lid. Also, the lid meets up with sink along a 45° angle, allowing the weight of the lid to sufficiently seal the lid to the sink without any latches. FIGS. 4a and 4b show the mechanism (bars) without the lid. At each side, there are four bars 30a, 30b, 30c, 30d and the two bars 30d are joined by a cross bar 31. FIG. 4a shows the positions of the bars when the lid is closed and FIG. 4b shows the bar position in the lid open position.

As mentioned above, a couple of application-specific modifications to the standard four bar mechanism were made to make it that much better for the user. First, when the lid is in the upright position, it actually prevents any water from dripping down on the front half of the working area, which gives plenty of space to the user to dry a part, load, and unload, without being dripped on. This can be seen in FIG. 5 where the lid is shown in the open position. The substantially vertical lid 40 has the front lip 41 around half way back over the sink basin 6 where the part to be washed is placed for washing.

Secondly the lid includes a special glove port, which extends farther into the machine. This overcomes another typical problem with prior art designs concerning interference from the gloves, as the lid is opened and closed. In the present invention, the gloves hang down from a point further into the machine than traditional glove ports—this keeps them out of the way when opening and closing the lid, and prevents them from becoming trapped between the lid and sink. This is best seen in FIG. 6 where the end 51 of the fixed glove port 50 (to which gloves are attached) never moves out beyond the front lip of the sink basin 6 even when the lid is at full extension during the opening process. The gloves therefore never move out of the area above the sink basin and therefore do not drip on the user or get caught in the lid as it is closed.

The sink basin is preferably a rotational moulded single piece made of any metal or a suitable plastic, for example MDPE (Medium Density Polyethylene), or tough polymeric material (e.g. ABS). This has been designed to be compatible with the hot aqueous solution, the soaps, the high pressures and the oils which will be present during operation. It is preferably large enough to accommodate a part which is 700 mm wide, 400 mm deep and 400 mm high. The typical dimensions of the basin are 710×503 mm. The sink basin is preferably of double thickness to provide rigidity and a suitable height above the floor.

The sink basin may optionally include a frame (not shown) on which to support the parts to be cleaned. Such a frame may be permanently attached to the sink or may be removable to enable larger parts to be accommodated and washed. The frame may be made of any suitable metal capable of withstanding the washing environment for example stainless or galvanised steel or aluminum. It could alternatively be any suitable plastic or other polymeric material. It may be up 1.3 m above the floor, typically 1.0 m. The overall sink basin, with or without the frame, should be able to hold a part weighing up to 75 kg.

The washer typically includes one high pressure nozzle although two or more may be present. The nozzle is a hand-held nozzle which will disperse a fan jet of water at about 400 psi and 2 gallons per minute. The nozzle and part will be handled by the user during operation using the integrated heavy duty gloves which are attached to the lid of the washer. The nozzle may be interchangeable such that different size and shape of nozzles can be put into the system to address a particular type of job. This may be dictated by the degree of soiling of the part, the shape of the parts, the strength of some or all of the part, the viscosity of the cleaning liquid or any other relevant variable as known by the person skilled in the art.

Turning to FIGS. 6 and 7 the integrated heavy duty gloves are secured to the lid of the washer at a distance 4-5 cm inset from the lid such that they do not become trapped when opening or closing the lid. The gloves are preferably made of a moldable or woven material that is suitable for use in the environment which is resistant to thermal conductivity and which is pliable but not easily abraded, punctured, ripped or torn when used. The gloves are optionally made from nitrile or PVC which is designed to protect the user from the temperature, pressure and chemical environment in which the parts are cleaned. A user would typically use their own glove liners, which may be new for each use of the machine, which promotes a more hygienic environment. The position of the gloves on the lid in relation to the whole machine has been determined such that the user is standing in the ideal ergonomic position when using the machine. This will reduce or eliminate back related injuries in users. The glove ports are arranged to be substantially at the outer sides of the front of the lid to provide the user with maximum scope to manipulate the nozzle and part within the sink basin.

In the base or bottom portion of the washer is housed the cleaning solution which is maintained in a standard sized 110 litre drum which meets the requirements of a UN/DOT shipping container. This enables the solution to be easily changed when necessary and for the dirty solution to be easily transported away for further treatment and disposal. The needs of a parts washer route based service organization requires the washing liquid to be transported as a product to the customer as well as back to a remediation facility when the liquid becomes a waste. This business model has been used for years using organic solvents, but the technology to design a system around a water based machine and the service drum has not previously been addressed.

The drum containing the washing liquid is connected by means of a new bung adaptor to a pump which in turn will supply the nozzle in the upper part of the washer. The importance of the pump connection is to avoid any extended fitting protruding from the side of the drum which would prevent the drum being considered to be a “proper shipping container” under the UN/DOT regulations. The bung adaptor is shown in further detail in FIGS. 8a and 8b and this is used to create a recess within the drum which incorporates the standard 2 inch drum fittings. This allows for proper closure of the drum for transportation while also providing a fixture to attach the suction side of the high pressure pump. The fixture may also include a screen filter to protect the pump from solid debris which may still be present in the washing liquid in the drum.

The bung adapter is designed in a manner to allow a fluid connection to the drum without the drum having fittings or external connectors protruding from the drum. The thread and flange arrangement allow for the adapter to be threaded into a standard 5 cm (2″) drum bung which maintains the integrity of the drum as a proper enclosure and meets the requirements of a UN or DOT shipping container.

The drum is an integral part of a route based solvent exchange enterprise as it provides the vessel for the solvent storage as well as the shipping container when the cleaning solvent reaches the end of its useful life. In a typical organic solvent based parts washer the drum exchange is carried out by removing the simple submergible pump out the top of the drum; the drum is then fitted with a closure and is then used as the shipping container for delivery of the waste material to an offsite disposal or recycling center.

A parts washer using a water based detergent must use a high pressure pump that requires a flooded suction. In order to provide that flooded suction a connection to the drum below the liquid level is required.

Referring to FIGS. 8a and 8b, the bung adapter 100 is a welded or molded recess that provides an area within the wall of a drum to house and protect a connection/coupling between the drum and the pump. The width and depth of this recess provides a housing for the quick release no drip hose connector 102 to be shielded within the outside diameter of the drum. The outside 104 of the adapter is designed with a standard male 5 cm (2″) npt butt thread and a full face flange 106. This design allows the adapter to slip inside the bung while the threads on the outside of the adapter thread into the bung opening of the drum. The flange incorporates a full face seal 108 which provides a liquid tight connection. The quick release hose connection is then threaded into the 1.25 cm (½″) threaded port 110 located on the back of the adapter which now allows a fully recessed hose connection point

The advantage of this arrangement is that it provides flooded suction to the pump, without external connectors protruding from the pump. The design maintains the integrity of the drum while providing an opening or port for pump connection. Providing an inlet or recess within the confines of a 5 cm (2″) bung opening, while maintaining the integrity of the drum is truly a unique approach with respect to using a standard shipping container as part of a cleaning system.

Also contained within the drum is a heater assembly and associated safety features. To ensure the integrity of the drum the entire heating assembly, which preferably includes a low level alarm and a thermostat, is mounted in a fashion that allows for quick removal from the drum and replacement of the shipping closure. The heater assembly is also quickly disconnected from the parts washer by use of one electrical connector, The entire assembly is contained with a 75 mm (3″) metal tube that is mounted to the drum closure (lid).

As discussed above, water based solvents require mechanical action (pressure) as well as heat to match the performance of organic solvents. The present invention is designed around a service drum, including the washing liquid, which requires removal and replacement. It is for this reason that the heating system is designed in such a way as to provide easy connection and disconnection from the washer so that the drum can be easily replaced at the appropriate time.

The present invention in a preferred embodiment uses a “heater assembly” 200 as shown in FIG. 9 which incorporates a heater or heating element 202, a thermostat 204 separated from the heating element by a spacer 203, and a low level float switch 206 and associated low level alarm (not shown), all within one removable assembly 210. This assembly 210 is preferably a 75 mm (3″) metal pipe and is attached to a custom designed removable lid 220 that can be disconnected from a dirty drum of solvent and reconnected to a clean drum with only one electrical connection. The assembly is capped by a sealing cap 208.

As the equipment is designed around a route service drum, removal and reconnection from drum to drum is an integral part of the business model. The advantages to this design are that the entire assembly can be connected and reconnected using one standard electrical connector and one standard clamp on lid arrangement. As all of the components in the assembly are in series so only one circuit is required to manage the temperature, heater and low level controls.

This equipment has the ability to be installed and connected to the drum with one standard electrical connector. This quick connect and disconnect allows for easy removal of the drum and replacement with a proper shipping closure. The entire assembly is mounted and housed on a drum lid that provided a closure during the use of the machine. When the custom drum lid 220 is removed from the drum for shipment of the used liquid, it is replaced with a standard lid closure that meets the requirements for a UN/DOT shipping container.

The washing liquid from the drum passes through the bung adaptor, through a standard flexible pipe to a pump. In a preferred embodiment, the pump may be a twin piston pump or a twin plunger pump which may have a maximum pressure of up to 68.9 Pa (1000 psi), a maximum flow rate of 3.0 gpm and a maximum speed of 1750 rpm. The pump will be selected to be appropriate to deal with the volume of liquid being used and the type of nozzle or nozzles being used. The pump in turn supplies the nozzle which is used in the upper part of the washer to clean the dirty parts.

The pump is controlled by means of a central control unit which may be placed at any appropriate part of the circuit. The central control unit will control the power to the pump, the power to the thermostat and heater. It will also control the alarms and the lighting in the upper part. The control unit may be controlled automatically by means of set programs which run for certain lengths of time and pre-determined temperatures and pressures, or the control may be managed manually, for example by use of a foot switch to start and stop flow around the system.

The drum also includes a down tube which extends from the sink basin in the upper part down through the customised removable lid and into the liquid solution. The excess liquid from the washing of the part in the sink basin passes through the down tube and back into the liquid solution. The tube is designed to extend a substantial way down into the drum, for example between a third and half way down the drum, so that there exists a passive or quiet zone at the top of the drum. FIG. 10 shows an example of the tube 110 extending about one third of the way down the drum 10. The excess liquid is discharged away from the passive zone 112 so that the turbulence created by the discharge is damped by the time it reaches the top of the drum. The passive or quiet zone allows the oil based liquids and the aqueous based liquids to separate through the differences in density and for the oil based layer to be removed as part of the clarification process.

A combination of a chemical and mechanical process is needed to allow for separation of contaminants from the washing solution. This system is designed to allow for continued use of the machine while also providing a quiet or passive zone area for full separation of oil and contaminants.

The down tube is designed to route water from the washing chamber through and under the oil layer. This down tube also incorporates a filter housing to remove small particulate matter. The down tube is located at a specific level to allow for water to be removed from this quiet zone above the down tube through a drain valve.

When a service technician begins the clarification of the water and during the use of the machine, water and turbulence entering the drum do not disturb the oil layer in the quiet zone. This oil will form over time and eventually be removed from the oil drain valve. During this process not all of the oil is removed and a small layer is allowed to form on top of the washing solution. The oil layer is important during the life cycle of the machine as it provides a blanket on top of the water which helps to slow evaporation and heat loss of the washing solution.

Another aspect of the present invention concerns the liquid solution remediation and treatment. After the washer has been used one or more times, the process of the present invention to use the drum as a water remediation and treatment vessel is initiated. A combination of soaps, chemical clarifiers, and the mechanical design of the machine allow for the current design to actually treat the washing solution within the machine and render out oils and contaminants. This allows a significant extension to the life of the washing solutions.

Contaminants entering the washer of the present invention consists mainly of dirt or silicas, and oil. In most washing applications the detergents used will mix with the oils and form an emulsion. This emulsion will also trap small particulates in suspension that would otherwise precipitate out of the solution and drop to the bottom of the drum. The present invention uses an oil releasing detergent that minimizes the formation of emulsions; however over time some oils will still remain within that emulsion. In order for the detergents to work effectively it is necessary to strip these oil and the accompanied particles out of the washing solution.

The detergent of the present invention has been designed to work with a specific clarifying solution that when introduced into the drum of solvent will cause an immediate separation of the oil from the washing solution. This process can take place in as little as fifteen minutes. The oil will immediately release from the cleaning solution and form a layer at the top of the drum. Once this layer is formed, a service technician or operator can open the oil drain valve and remove the layer of oil from the top of the washing solution.

In general most aqueous washing machines use either an oil water separator, or a mechanical belt system to remove oil from the washing solution. These remedies work well for free oil, but have little effect on oils trapped in an emulsion within the washing liquid. The present invention, by using a chemical and mechanical solution, is able to strip a much higher percentage of trapped oil from the washing solution.

The specific design of the drum and the washer apparatus allow a freeboard area or quiet zone at the top of the drum that is isolated from the turbulence of the pump and washing solution entering the drum. This quiet zone provides an area for the oil to reside until it is drained off during service through the oil drain valve. The proximity of the pump, down tube, and drain valve all allow for this clarifying process to be carried out while the machine is in operation. Once the oil is drained from the machine, the water level and soap levels in the drum are topped off and the machine is available for continued use having had the oil removed from the solution.

The detergent that has been developed to work within the present invention is a binary product consisting of a built base and an activator which also acts as a wetting agent, anti-redeposition, and an anti-foam. The synergy between the base and activator has been developed to give a balanced performance where no solvents are used in a totally aqueous system. The components are incompatible as a stable single component mixture but when mixed in diluted form, form a synergistic blend that cleans effectively, rejects oil, has low foam and does not attack the metal components being cleaned. The balance gives compatibility with coagulants to prolong the life of the fluid, at relatively low temperatures of ≦50° C. and with low foaming.

The activator or activators comprise a synergistic mixture of surfactants optimised to give a performance over a wide range operating parameters, whilst maintaining the flexibility to be tailored to individual customer requirements. All the surfactants used are biodegradable and meet the standard EC/648/2004 (the European Detergent Directive including rules on the biodegradability of detergents and surfactants).

The base or bases comprise a heavily built phosphate, NTA version for heavy duty high performance cleaning optimised for the present invention. Chemically balanced, the base is suitable for cleaning ferrous parts, aluminum and other soft metals. As an alternative, a balanced, non-phosphate version has been developed where the use of phosphate is restricted and a non-phosphate, non-NTA/EDTA version is used in places where severe restrictions exist.

In the mixture the ratio of activator to base is intrinsic to the performance which has been specifically designed for the present invention. A primary ratio of base to activator of about 5 parts activator to about 2 parts base may be used. This ratio can, of course, be varied depending on the soil being removed and the components being cleaned. The ratio can be optimised according to the customer requirements. The mixture contains no VOC's and provides a composition that works for a variety of dirty parts, including: mixed metal components, primarily steels; yellow metal components e.g. copper, bronze; aluminum and zinc based components; magnesium containing alloys; and polymers, rubbers and plastics. This wide range of parts includes all that might be found on a motor vehicle and which may be removed for cleaning.

The coagulant used in the present invention can be non-ionic, cationic or anionic depending on the soil contamination in the liquid. It coagulates the oily based soils which then float to the surface and are removed by skimming or decantation. It does not remove the surfactant/detergent components. It allows the base fluid (aqueous based) to be reused and topped up with fresh base and activator if necessary, hence prolonging the useful life of the cleaning fluid. It increases the clarity and cleanliness of the liquid reducing recontamination of parts being cleaned with previously removed soils. It improves operator visibility of the work piece being cleaned. Typically the level of coagulant is 0.01% by volume but this can vary depending on the level and nature of the contamination.

The concentration of the base and activator in use can be fixed dependent upon the service interval required. Through field trials a working strength of 1% activator and 2.5% base was found suitable for most applications.

### EXAMPLE

Testing was done to show that the correct combination of base and activator used in the present invention has a synergy. This can be demonstrated by cleaning more efficiently or at least to the same level as competitor's products, but without foaming and allowing efficient oil separation and coagulation. The foaming characteristics were determined by comparing the Pure Solve ADS 40 (an automatic rather than manual washer) and the present invention because it has been found that standard laboratory foam measuring techniques do not correlate well with practical experience. The high shear experienced by the liquid in both the Pure Solve ADS 40 and the present invention tends to break down standard anti-foam systems leading, in time, to a stable high density foam which overwhelms the sump of the ADS 40 and the sink basin of the present invention.

Coagulant Tests

Solutions of waste liquor were taken from field trials with various soils and various soil contamination levels. The optimum level of coagulant was determined using these liquor samples. The maximum level of coagulant was found to be 0.2 g/l with a minimum of 0.05 g/l.

The effectiveness of the clarification is exemplified by the separation over time of the oil based fluid from the aqueous fluid.

The pH of the system was measured and a pH titration curve was used to determine the level of base components remaining in the cleaning liquid after use. A corresponding additive treatment rate was developed for bringing liquid back to its working strength.

The synergy between the chemistry and kinetic energy of the present invention facilitates the use of lower temperature programmes. Typical operating temperatures are as high as 90° C. for existing equipment. The synergy of the apparatus of the present invention allows the use of temperatures from as low as 20° C. but typically these will be in the range 25-75° C., for example 40-60° C.

In operation, the clarifier is introduced into the washing liquid and time (approximately 15 to 20 minutes) is allowed for the separation to occur, a special valve located on the side of the service drum is opened to allow the oil and contaminants to be drained from the machine. These contaminants make up the bulk of the soil within the dirty washing solution. When these contaminants are removed, the washing solution is recharged with detergents. The water within the drum will continue to be used through washing and clarifying cycles.

At some point the water within the washing solution will be replaced as the chemistry becomes difficult to maintain over long periods of time. This liquid will need to be shipped as a waste in a proper DOT/UN shipping container. The machine itself has been designed around a pre approved UN/DOT shipping container, which allows the machine to meet the criteria for a route based fully serviceable machine. The quick connect fluid lines as well as the heating element and level controls are all incorporated within and around this container. When the machine requires service a technician quickly de-couples the drum from the machine, attaches a DOT/UN closure and the waste water is available to be shipped.

The present invention is the only device that fully incorporates:
The cleaning ability obtained through high temperature/high pressure cleaning in a route based, drum mounted parts cleaning machine.
The ability to couple a high pressure system onto a removable service drum that incorporates an onboard clarifying reactor.
Incorporation of a UN/DOT shipping container into a manual parts washer.

The environmental benefits of this are clear and include the following. By designing a water based manual parts cleaning system that effectively cleans much better than organic solvents, the present invention provides users with the ability to shift from those organic solvents to a more environmentally friendly water based solution.

Using organic solvents exposes the user to harsh vapors and generates VOC within the lower atmosphere. Many countries and agencies have tried to eliminate the organic solvents from their inventories, but the availability of alternative cleaning methods and chemistries have not been available until now.

Extending the life of the washing solution also aids in providing alternative methods that aid in Environmental protection. Typical automatic heated washer machines require frequent replacement of the washing solution. This replacement generally requires the waste to be transported long distances where the solution is eventually treated and released into the environment.

The oil that is chemically stripped from the washing solution is manually removed by the service technician. This oil is introduced into the used oil stream of the user or third party collector and ultimately recycled. The life of the water is extended dramatically, as treatment of the water removes most of the contaminants.

The user benefits, in comparison to using organic solvents by avoiding exposure to toxic chemical, having a safe machine which is ergonomically designed for more comfortable operation.

### EXAMPLES

Results of tests using the apparatus and system of the present invention compared with Organic Solvents.

Tests were conducted comparing the effectiveness of the aqueous based solution of the present invention compared with organic based manual machines. The time difference to clean parts is dramatic.

A typical roller bearing that is contaminated with heavy bearing grease took 10 minutes to clean using organic solvents and a parts cleaning brush as the manual cleaning component. This same typical bearing was cleaned using the present invention and the process took less than 4 minutes.

A fine mesh filter basket contaminated with fiber, carbon and grease was cleaned with an organic solvent and a parts cleaning brush for over 10 minutes and many of the contaminants remained on the part as the solvent was unable to reach inside the small mesh areas. This same screen was cleaned in less than 5 minutes using the present invention. Some small amounts of carbon and calcium remained at the end of the 5 minute cleaning cycle, but there was a dramatic difference between the effectiveness of the two systems.

1. A parts washer comprising: an upper portion including a sink basin, a lid through which two integrated heavy duty gloves are passed and fixed, a viewing panel, a high pressure nozzle, and a drain from the sink basin; and a lower portion including a drum for containing the aqueous cleaning solution, a high pressure pump for pumping solution from the drum to the high pressure nozzle, a down tube passing from the drain from the sink basin in the upper portion into the drum for passing excess liquid from the upper portion back to the lower portion for regeneration and re-use, heating means within the drum for heating the cleaning solution, and safety and control means for operating the parts washer.

2. A parts washer as claimed in claim 1, in which the upper section further includes a frame for supporting the part to be washed.

3. A parts washer as claimed in claim 1, in which the upper section further includes an air knife for cleaning the viewing panel.

4. A parts washer as claimed in claim 1, in which the drum is configured to meet the requirements to be a shipping container.

5. A parts washer as claimed in claim 1, in which the drum has a specially adapted bung to enable liquid to pass from the drum to the pump without extending past the outside of the drum.

6. A parts washer as claimed in claim 1, in which the drum includes an integrated drain.

7. A parts washer as claimed in claim 1, in which the lid is a four bar lid mechanism.

8. A parts washer as claimed in claim 1, in which the lid is locked by means of a reed switch.

9. A parts washer as claimed in claim 8, in which the reed switch is located between two layers of the lid.

10. A parts washer as claimed in claim 1, in which the nozzle is a manual nozzle which can be moved within the sink.

11. A parts washer as claimed in claim 1, in which the nozzle is fixed within the sink basin.

12. A parts washer as claimed in claim 11, in which the nozzle may be moved to another fixed location within the sink basin and/or the nozzle may be adjusted to be directed towards a different part of the sink basin.

13. A parts washer as claimed in claim 1, in which the upper portion further includes an air spray to dry a washed part.

14. A method of washing an article in a parts washer comprising a sink basin disposed in an upper portion of the washer, a nozzle for spraying a cleaning liquid, a lid, integrated heavy duty gloves which pass through the lid, a drum, and a pump, the method comprising:
placing the article inside the upper portion of the parts washer;
closing and locking the lid of the washer;
pumping cleaning liquid from the drum through the nozzle and into the sink basin;
accessing the article inside the parts washer through the heavy duty gloves;
spraying the article with jets of cleaning liquid from the nozzle to clean the dirt off the article; and
draining excess cleaning liquid through a drain to a down tube and into the bottom portion of the drum.

15. A method of regenerating a cleaning solution in a parts washer comprising a sink basin, a drum containing an aqueous based cleaning solution at a level sufficiently below the top surface to maintain a quiet zone at the top of the drum, a down pipe fluidly connecting the sink basin and the drum, the method comprising:
transferring a dirty solution comprising oil based waste from the sink basin through the down pipe into the drum;
adding a clarifier to the aqueous based mixture in the drum to substantially separate the aqueous solution from the oil based waste, the quiet zone at the top of the drum allowing the different parts to separate;
drawing off the separated oil based waste;
adding fresh water to the aqueous solution to reach an appropriate fluid level within the drum;
chemically testing the solution in the drum; and adding additional cleaning solution if needed to achieve a desired chemical composition.

16. A method as claimed in claim 15, in which the parts washer further comprises a lid through which two integrated heavy duty gloves are passed and fixed, a viewing panel, a high pressure nozzle, and a high pressure pump for pumping solution from the drum to the high pressure nozzle, and the method further comprises the step of:
heating the aqueous solution in the drum; means within the drum for heating the cleaning solution.

17. A parts washer as claimed in claim 3 in which the drum is configured to meet the requirements to be a shipping container.

18. A parts washer as claimed in claim 17 in which the drum has a specially adapted bung to enable liquid to pass from the drum to the pump without extending past the outside of the drum.

19. A parts washer as claimed in claim 17 in which the lid is a four bar lid mechanism.

20. A parts washer as claimed in claim 19 in which the lid is locked by means of a reed switch.
